(19) United States
(12) Patent Application Publication
(10) Pub. No.: US 2026/0106362 A1
(43) Pub. Date: Apr. 16, 2026

(54) QUADRUPOLE MASS FILTERS AND RELATED SYSTEMS AND METHODS

(71) Applicants: Massachusetts Institute of Technology, Cambridge, MA (US); Empiriko Corporation, Newton, MA (US)

(72) Inventors: Luis Fernando Velasquez-Garcia, Newton, MA (US); Colin Christian Eckhoff, Cambridge, MA (US); Pam Randhawa, Newton, MA (US)

(73) Assignees: Massachusetts Institute of Technology, Cambridge, MA (US); Empiriko Corporation, Newton, MA (US)

(21) Appl. No.: 18/877,959

(22) PCT Filed: Jun. 2, 2023
(86) PCT No.: PCT/US2023/067882

§ 371 Date: Dec. 20, 2024

Related U.S. Application Data
(60) Provisional application No. 63/367,513, filed on Jul. 1, 2022.

(51) Int. Cl. H01P 1/207

(52) U.S. Cl. CPC H01P 1/207

(57) ABSTRACT

What is disclosed herein are quadrupole mass filters (QMF) and related methods. The QMFs may have a relatively high surface roughness and/or be additively manufactured, wherein the QMF may be configured for ion filtering in a mass spectrometer. The methods may comprise: a. applying transverse sections to produce a dielectric part; b. masking one or more surfaces of the dielectric part to produce a partially masked dielectric part; c. positioning a metal on the partially masked dielectric part with a metal conductor to produce one or more electrically conductive surfaces on the printed part; and d. removing the mask from the printed part to produce a finished QMF; wherein the QMF is configured for ion filtering in a mass spectrometer.

### RELATED APPLICATIONS

This application claims priority under 35 U.S.C. § 119(e) to U.S. Provisional Patent Application No. 63/367,513 , filed Jul. 1, 2022, and entitled “Monolithic Quadrupole Mass Filters,” which is incorporated herein by reference in its entirety for all purposes.

### TECHNICAL FIELD

Quadrupole mass filters and related systems and methods are generally described.

### SUMMARY

This Summary introduces a selection of concepts in simplified form that are described further below in the Detailed Description. This Summary neither identifies key or essential features, nor limits the scope, of the claimed subject matter.

In one aspect, a quadrupole mass filter (QMF) is disclosed. In some embodiments, the QMF comprises a dielectric part; and one or more conductive surfaces on the dielectric part, wherein the one or more surfaces are present on greater than or equal to 50% of a surface area of the dielectric part.

In some embodiments, the QMF comprises a dielectric part comprising a composite of a polymer and inorganic particles; and one or more conductive surfaces on the dielectric part; wherein the QMF is configured for ion filtering in a mass spectrometer.

In certain embodiments, the QMF comprises a dielectric part; and four conductive surfaces on the dielectric part; wherein a surface roughness of each of the four conductive surfaces is greater than or equal to 2 microns and less than or equal to 100 microns as measured by the ASME B46.1-2019 standard test, and wherein the QMF is configured for ion filtering in a mass spectrometer.

In some embodiments, the QMF comprises a dielectric part; and one or more conductive surfaces on the dielectric part, wherein the QMF is configured for ion filtering in a mass spectrometer, and wherein the dielectric part is made by additive manufacturing.

In certain embodiments, the QMF comprises a dielectric part; and one or more conductive surfaces on the dielectric part, wherein the QMF is monolithic and does not comprise silica.

In some embodiments, the QMF comprises a dielectric part; and one or more conductive surfaces on the dielectric part, wherein the QMF is monolithic.

Certain aspects are related to methods of making QMFs. In some embodiments, the method comprises a) applying transverse sections to produce a dielectric part; b) masking one or more surfaces of the dielectric part to produce a partially masked dielectric part; c) positioning metal over the partially masked dielectric part to produce one or more electrically conductive surfaces on the dielectric part; and d) removing the mask from the partially masked dielectric part to produce a finished QMF.

One aspect of the disclosure herein is a method of making quadrupole mass filters (QMF), wherein the method comprises using a printer to apply transverse sections to produce a dielectric part with rods 1-100 cm long surrounding a hole with 1-100 mm inner diameter; lacquering one or more surfaces of the printed part to produce a partially masked printed part; plating the lacquered printed part with a metal conductor to produce one or more electrically conductive surfaces on the printed part, wherein the plating thickness is greater than 0.1 μm and less than 1 mm; and removing the lacquer masking from the printed part to produce electrically conductive rods and hence a finished QMF; wherein the QMF is configured for ion filtering in a mass spectrometer.

In one embodiment of the methods disclosed herein, antialiasing is applied to the slicing data.

In one embodiment of the methods disclosed herein, the printed part is made of glass ceramic photocurable polymer resin.

In one embodiment of the methods disclosed herein, the printed part is mounted on a set of pillars.

In one embodiment of the methods disclosed herein, the block of resin has a build volume of 110×60×138 mm.

In one embodiment of the methods disclosed herein, the rods are between 2 cm to 18 cm long, surrounding a hole with 2 mm to 6 mm inner diameter.

In one embodiment of the methods disclosed herein, the plating thickness is 15 μm to 50 μm.

In one embodiment of the methods disclosed herein, the plating comprises copper, gold, or nickel boron.

One aspect of the disclosure herein is a quadrupole mass filter (QMF), comprising a monolithic structure wherein the monolithic structure comprises four rods having hyperbolic shape where the rods are shells with an internal truss structure; hefty struts support each rod; and a cylindrical enclosure; wherein corners of the quadrupole rods are not directly connected.

In one embodiment disclosed herein, the QMF is coated with a plating comprising copper, gold, or nickel boron.

In one embodiment of the QMF disclosed herein, the plating has a thickness of 15 μm to 50 μm.

In one embodiment of the QMF disclosed herein, each electrode is galvanically isolated from each other.

In one embodiment of the QMF disclosed herein, the resistance between electrodes is greater than 100 MΩ.

The following Detailed Description references the accompanying drawings which form a part this application, and which show, by way of illustration, specific example implementations. Other implementations may be made without departing from the scope of the disclosure.

### BRIEF DESCRIPTION OF THE DRAWINGS

Non-limiting embodiments of the present disclosure will be described by way of example with reference to the accompanying figures, which are schematic and are not intended to be drawn to scale unless otherwise indicated. In the figures, each identical or nearly identical component illustrated is typically represented by a single numeral. For purposes of clarity, not every component is labeled in every figure, nor is every component of each embodiment of the disclosure shown where illustration is not necessary to allow those of ordinary skill in the art to understand the disclosure. In the figures:

FIG. 1A-1D are schematic diagrams of a monolithic QMF, according to some embodiments;

FIGS. 2A-2B are schematic diagrams showing conductive surfaces on dielectric parts, according to some embodiments;

FIGS. 2C-2E are schematic diagrams showing dielectric parts, according to some embodiments;

FIG. 2F is a schematic diagram of a mass spectrometer, according to some embodiments;

FIGS. 3A-3B are close-up photos of part electrodes, according to some embodiments;

FIG. 3C is a cross-sectional image of a conductive surface on a dielectric part, according to some embodiments;

FIG. 4 is an image of a QMF set up to act as a mass analyzer, according to some embodiments;

FIG. 5 is a plot of steady state detector currents with selective field settings for argon, according to some embodiments;

FIG. 6 is a mass spectrum showing a peak for filtering Ar using a quadrupole mass filter, according to some embodiments; and

FIG. 7 is a schematic diagram illustrating the arrangement of a traditional quadrupole mass filter.

### DETAILED DESCRIPTION

Mass spectrometry (MS) is the gold standard for characterizing matter; its quantitative resolving and qualitative analyzing powers are unrivaled, making MS instrumental to countless technical fields, including the food, oil, chemical, pharmaceutical, and healthcare industries. The rise of point-of-care (PoC) devices in scientific and medical instrumentation naturally introduces the need for PoC MS devices to achieve high performance analysis at the point-of-care. Conventional miniaturized mass spectrometers and methods of making them, however, are not simple and lead to poorly performing mass spectrometers (e.g., lower resolving power). For example, miniaturized assembly hardware in conventional mass spectrometers is generally imprecise and leads to misaligned electrodes and corresponding poor device performance.

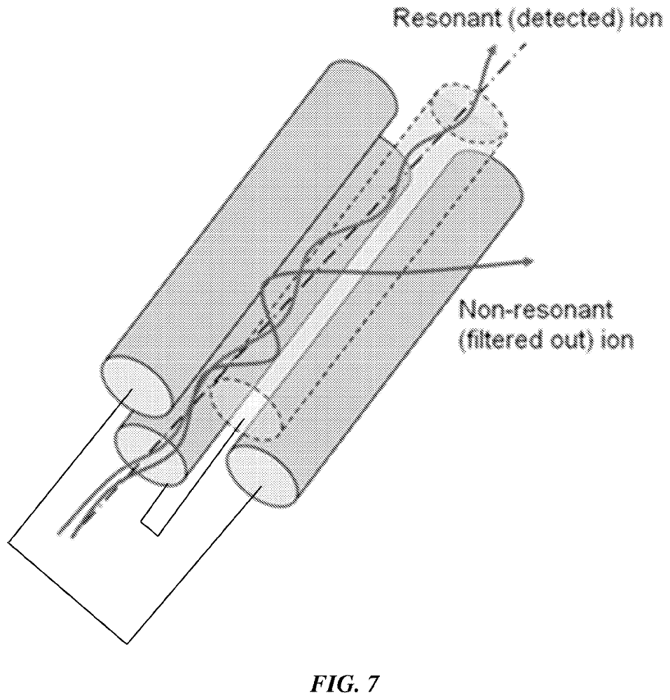

Quadrupole mass filters (QMFs), also sometimes referred to as quadrupole mass analyzers, are a type of mass filter used in mass spectrometry systems. FIG. 7 is a schematic diagram illustrating the arrangement of a traditional QMF. QMFs generally comprise four parallel, elongated electrodes, usually in the form of cylindrical rods. In traditional quadrupole mass spectrometers (QMSs) the QMF is the mass analyzer: the component of the instrument responsible for selecting sample ions based on their mass-to-charge ratio (m/z). Ions are separated in a the QMF based on the stability of their trajectories in the oscillating electric fields that are applied to the rods. Each opposing rod pair is connected together electrically, and high voltage, high frequency power signals can be sent to each of the rods, allowing the quadrupole mass analyzer to filter specific mass-to-charge ratios of particles traveling through the device. Ions travel down the quadrupole between the rods, and only ions of a certain mass-to-charge ratio will reach the detector for a given ratio of voltages, while other ions have unstable trajectories and will collide with the rods. This permits selection of an ion with a particular m/z or allows the operator to scan for a range of m/z-values by continuously varying the applied voltage.

The versatility and high performance of QMFs have resulted in their wide use in mass spectrometry. Unfortunately, as with general mass spectrometers, miniaturizing QMFs often grossly degrades performance. In particular, device geometries compatible with batch fabrication contain unideal shapes that reduces the filtering resolution of the mass spectrometer. Moreover, conventional QMFs utilize high-precision machined metallic cylinders as electrodes, which may be expensive to fabricate and/or difficult to miniaturize in a batch fabrication. Accordingly, improved systems and methods are needed.

Some aspects of the present disclosure are generally related to such improved miniaturized QMFs. In some cases, methods of designing and fabricating QMFs by harnessing additive manufacturing (AM) to circumvent these limitations and attain compact MS systems (e.g., miniaturized) with adequate performance for analytical applications are described.

According to some embodiments, the present disclosure describes a QMF. In some cases, the QMF comprises a dielectric part and one or more conductive surfaces on the dielectric part. In some such cases, the QMF comprises a dielectric part and four conductive surfaces on the dielectric part, wherein the QMF is configured for ion filtering in a mass spectrometer. The dielectric part may be made by additive manufacturing, in accordance with some embodiments, which may impart certain advantages to the QMF. For example, additive manufacturing may facilitate precise manufacturing, allowing for relatively easy alignment of the QMF electrodes in certain cases. Additive manufacturing may also facilitate precise manufacturing of miniaturized QMF parts, allowing for miniaturization of the QMF. The ability to use additive manufacturing to make QMFs with adequate performance was unexpected. For instance, in certain embodiments, the surface roughness of the conductive surfaces of the QMF may be relatively high, which generally is considered detrimental to ion filtering performance in conventional QMFs. In some such cases, the surface roughness may be greater than or equal to 2 microns. However, the inventors have recognized in the context of the present disclosure that a QMF having a relatively high surface roughness may still adequately filter ions, in accordance with some embodiments.

According to some embodiments, the QMF comprises a dielectric part and one or more conductive surfaces over the dielectric part. As described elsewhere herein, in some cases, the dielectric part may be additively manufactured. In some such cases, additive manufacturing facilitates precisely made monolithic dielectric parts. The precision with which the dielectric part is made, in accordance with certain embodiments, can make it relatively easy to fabricate a QMF with sufficient alignment of the QMF electrodes. For example, if the dielectric part is made with sufficient alignment of the surfaces of the dielectric part over which the electrically conductive surfaces are formed, the electrically conductive surfaces (which can be used as electrodes in the QMF) will be sufficiently aligned for adequate QMF performance.

In certain embodiments, the QMF may be monolithic. As used herein, the term “monolithic” is used to describe a solid object where all of the components of the solid object are mechanically inseparable. “Mechanically inseparable” refers to an arrangement between components where no component can be detached from the other components without fracturing, irreversibly deforming, disintegrating, and/or otherwise irreversibly damaging at least one of the components. For example, in some embodiments, the monolith of the QMF comprises a dielectric part that is mechanically inseparable from one or more conductive surfaces, e.g., each of the four conductive surfaces used as electrodes. In some embodiments, the dielectric part is monolithic such that each surface on which the electrode conductive surfaces (e.g., four electrode conductive surfaces) are deposited may be mechanically inseparable from the remaining surfaces on which the electrode conductive surfaces are deposited.

In some embodiments, a monolithic part has a substantially consistent chemical composition throughout its volume. For example, in some embodiments, the dielectric part is a monolith that has a substantially consistent chemical composition. A “substantially consistent chemical composition” is used herein in a manner consistent with its ordinary meaning in the art, and is generally used to refer to an essentially homogeneous composition. For example, a monolithic part that has a substantially consistent chemical composition may be made of a single material or it may be a composite of two or more materials, where each material is distributed evenly throughout the volume of the monolithic part.

In some embodiments, across each and every contiguous volume of the monolithic part that occupies 5% of the part, the concentration of each chemical component within each contiguous volume of the monolithic part varies by less than or equal to 20%, less than or equal to 10%, or less than or equal to 2% relative to the average concentration of that chemical component within the entire part. In some embodiments, across each and every contiguous volume of the monolithic part that occupies 1% of the part, the concentration of each chemical component within each contiguous volume of the monolithic part varies by less than or equal to 20%, less than or equal to 10%, or less than or equal to 2% relative to the average concentration of that chemical component within the entire part. In some embodiments, across each and every contiguous volume of the monolithic part that occupies 0.1% of the part, the concentration of each chemical component within each contiguous volume of the monolithic part varies by less than or equal to 20%, less than or equal to 10%, or less than or equal to 2% relative to the average concentration of that chemical component within the entire part.

In some embodiments, the monolithic part can be an integrally formed part. As used herein, an “integrally formed” part is one that has been formed as a single part, as opposed to one formed of multiple parts that are joined together (e.g., using an adhesive). Integrally formed parts may be made, for example, via additive manufacturing (e.g., 3-D printing), sintering, subtractive machining, and the like. The use of integrally formed monolithic dielectric parts can, in accordance with certain embodiments, make alignment of the electrode conductive surfaces of the QMF easier.

In certain embodiments, the monolithic part is not a part that has been made by irreversibly adhering separate parts to form a larger part.

As noted above, in some embodiments, the QMF comprises one or more conductive surfaces. In some cases, the one or more conductive surfaces comprise four conductive surfaces. Generally, the conductive surfaces of the QMF that are aligned and configured as electrodes of the QMF are referred to herein as “electrode conductive surfaces.” In each embodiment below in which a conductive surface and/or a property thereof is described, that conductive surface may be, in accordance with certain embodiments, an electrode conductive surface of the QMF.

According to some embodiments, the QMF comprises four electrode conductive surfaces on the dielectric part, wherein the four electrode conductive surfaces are elongated, with the elongated dimension of each of the four electrode conductive surfaces aligned along a longitudinal axis of the QMF. In some embodiments, each of the four electrode conductive surfaces may be substantially parallel to the remaining electrode conductive surfaces. Two surfaces are said to be “substantially parallel” to each other when there is at least one line segment on the first surface that extends from one outer boundary of the first surface to a second outer boundary of the first surface that is within 10 degrees of parallel to at least one line segment on the second surface that extends from one outer boundary of the second surface to a second outer boundary of the second surface. In some embodiments, two surfaces that are substantially parallel are arranged such that there is at least one line segment on the first surface that extends from one outer boundary of the first surface to a second outer boundary of the first surface that is within 5 degrees of parallel (or within 2 degrees, or within 1 degree, or within 0.1 degrees, or within 0.01 degrees of parallel) to at least one line segment on the second surface that extends from one outer boundary of the second surface to a second outer boundary of the second surface. In other cases, each of the four electrode conductive surfaces may be substantially curved, for example, like a horseshoe, and thus may not be substantially parallel to remaining conductive surfaces. However, in some such cases, the four electrode conductive surfaces may still be aligned and configured for ion filtering in a mass spectrometer.

In some embodiments, the QMF operates using exactly four conductive surfaces as electrode conductive surfaces. In other embodiments, additional electrode conductive surfaces can be employed.

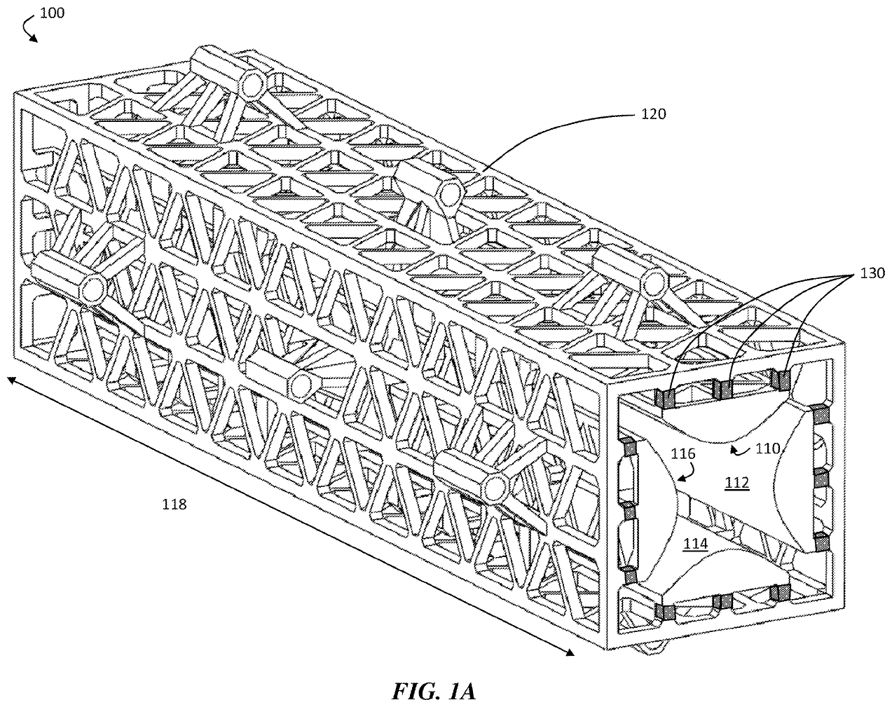

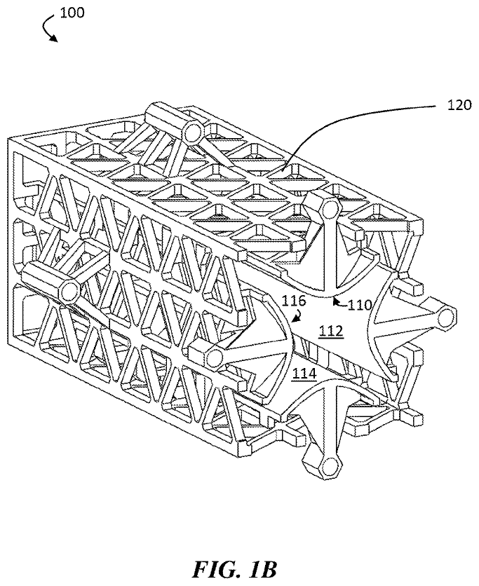

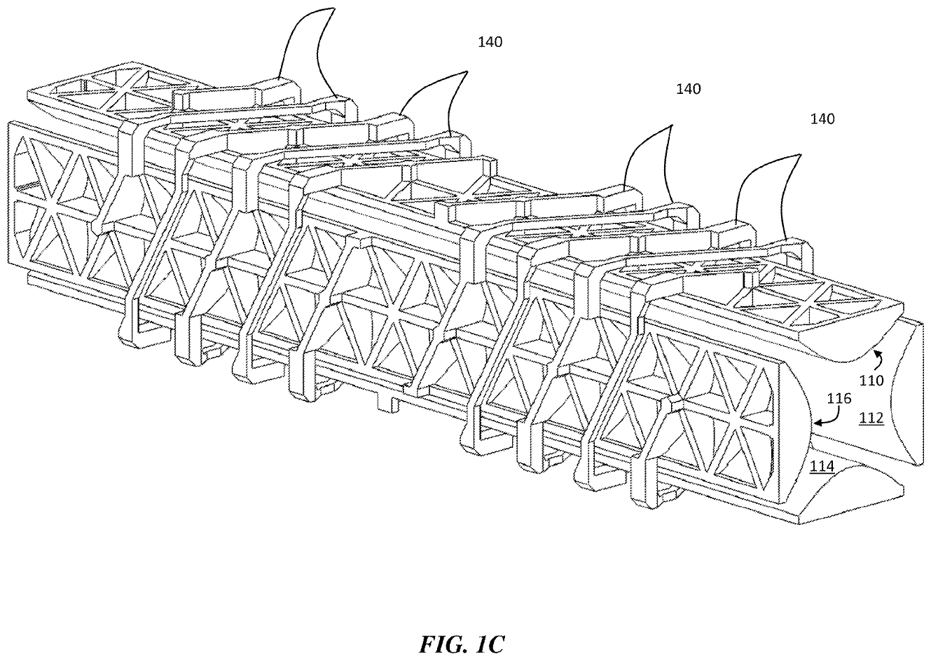

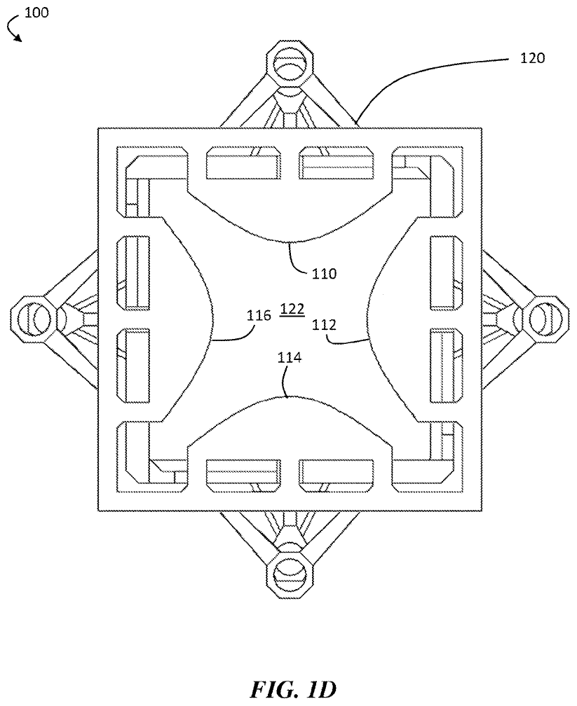

FIGS. 1A-C show schematic diagrams of an example embodiment of a QMF 100. FIG. 1A shows the QMF 100 comprising a dielectric part and four conductive surfaces 110, 112, 114, and 116 (which can be electrode conductive surfaces) on the dielectric part. The conductive surfaces 110, 112, 114, and 116 (each of which can be, for example, formed on the dielectric part) are elongated along the longitudinal axis (e.g., along dimension 118) of the QMF. In the set of embodiments illustrated in FIGS. 1A-1D, each of the conductive surfaces are connected to the overstructure 120 of the dielectric part by connection points 130 on either end of the QMF 100. The dielectric part at connection points 130 does not have conductor on it, and thus connection points 130 electrically isolate each of the four conductive surfaces 110, 112, 114, and 116 from each other (e.g., until electrical connections are made between electrode pairs via wiring or another pathway).

FIG. 1B is a cross sectional view of the QMF 100 that shows the four conductive surfaces 110, 112, 114, and 116 are not connected to the overstructure 120 along the length of the overstructure 120, but rather, are only connected to the overstructure 120 by connection points 130, as shown in FIG. 1A.

In certain embodiments, the electrode conductive surfaces can have a convex shape when viewed from a position between the electrodes. For example, referring to FIGS. 1A-1D, each of electrode conductive surfaces 110, 112, 114, and 116 has a convex shape when viewed from position 122 shown in FIG. 1D. As noted elsewhere herein, the convex shape of electrode conductive surfaces can be any of a variety of shapes such as, for example, cylindrical, hyperbolic, or others. In some embodiments, it can be particularly advantageous to employ electrode conductive surfaces having a hyperbolic shape.

In certain embodiments, electrical connections can be established between the electrode conductive surfaces, for example, such that opposing electrode conductive surfaces within the QMF are electrically connected to establish a first pair of electrode conductive surfaces that are electrically connected to each other and a second pair of electrode conductive surfaces that are electrically connected to each other. For example, in some embodiments, a first electrical connection is made between conductive surface 110 and conductive surface 114 to form a first electrode pair, and a second electrical connection is made between conductive surface 112 and conductive surface 116 to form a second electrode pair. FIG. 1C shows a partial schematic diagram of the QMF 100, wherein the overstructure 120 is not shown. Here, wires 140 are configured to physically connect opposite conductive surfaces (e.g., conductive surface 110 is connected with conductive surface 114 and conductive surface 112 is connected with conductive surface 116). Internally connecting the conductive surfaces 110, 112, 114, and 116 via wires 140 after plating the dielectric part with one or more conductive surfaces as described elsewhere herein may facilitate electronic connections to the conductive surfaces 110, 112, 114, and 116 when using the QMF 100. FIG. 1D shows a cross-sectional view of QMF 100, when viewed down the longitudinal axis of the QMF.

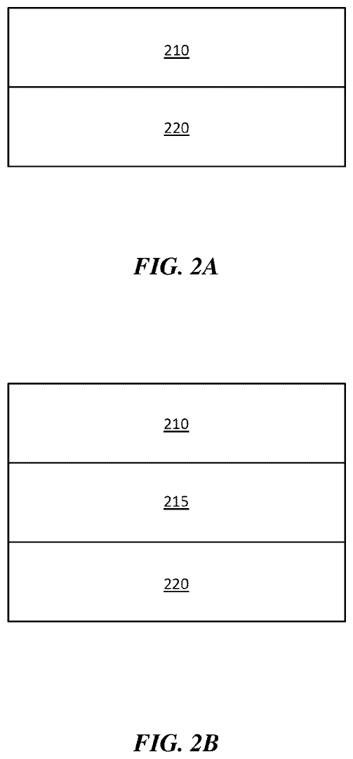

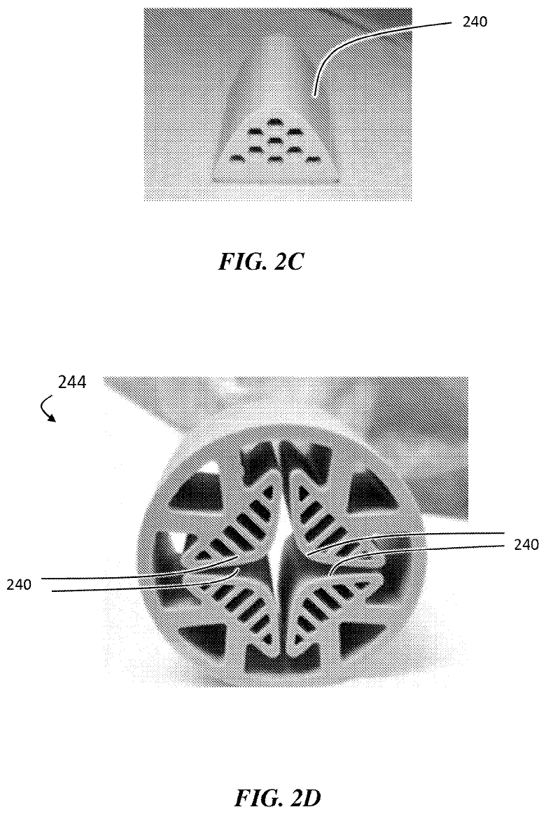

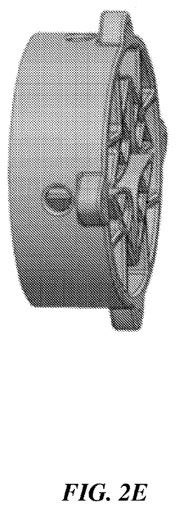

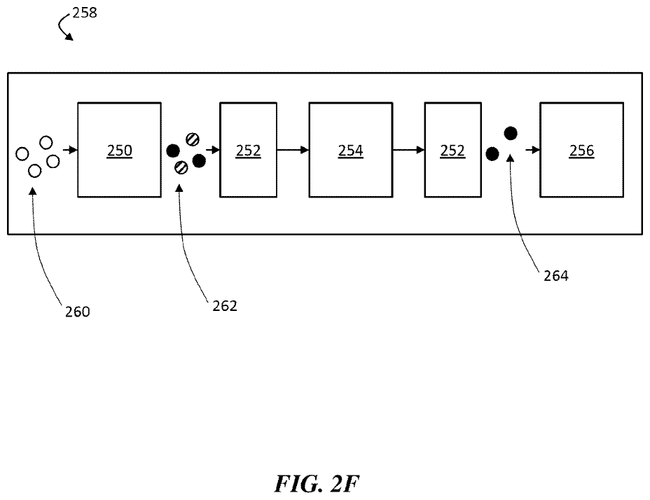

As noted above, the QMF, according to some embodiments, may comprise one or more conductive surfaces on the dielectric part (e.g., four electrode conductive surfaces). In some cases, the one or more conductive surfaces (e.g., electrode conductive surfaces) may be formed directly on the dielectric part. For example, consider the schematic diagram show in FIG. 2A. Here, conductive surface 210 is directly on the dielectric part 220. In some embodiments, such as the embodiment shown in FIG. 2B and described elsewhere, one or more intervening materials (e.g., 215) can be present between dielectric part (e.g., 220) and the conductive surface (e.g., 210).

In some embodiments, one or more of the conductive surfaces (e.g., the electrode conductive surfaces) is part of a conformal layer that is positioned over at least a portion of the dielectric part. For example, referring to FIG. 1, in some embodiments, conductive surface 110 is part of a first conformal layer that is positioned over a first portion of the dielectric part, conductive surface 112 is part of a second conformal layer that is positioned over a second portion of the dielectric part, conductive surface 114 is part of a third conformal layer that is positioned over a third portion of the dielectric part, and conductive surface 116 is part of a fourth conformal layer that is positioned over a fourth portion of the dielectric part, In certain embodiments, one or more other conductive surfaces can also be parts of conformal layers over one or more other portions of the dielectric part. The conformal layers of conductive material over the dielectric part can be arranged such that the conductive surfaces have substantially the same shape as the underlying portion(s) of the dielectric part. In certain embodiments, the thickness of the layer of conductive material (e.g., that includes the one or more conductive surfaces, such as one, more, or all of the electrode conductive surfaces and/or any other conductive surfaces) can be relatively consistent over the underlying dielectric part. For example, in certain embodiments, the thickness of the layer of conductive material, over at least 80% of the surface area of the layer of conductive material, does not deviate from the average thickness of the layer of conductive material by more than 50%, more than 40%, more than 30%, more than 20%, more than 10%, or more than 5%. In some embodiments, the thickness of the layer of conductive material, over at least 90% (or at least 95%, at least 98%, or at least 99%) of the surface area of the layer of conductive material, does not deviate from the average thickness of the layer of conductive material by more than 50%, more than 40%, more than 30%, more than 20%, more than 10%, or more than 5%.

In some embodiments, the dielectric part extends along a large portion of the elongated dimensions of each of the electrode conductive surfaces (which are the dimensions of the electrode conductive surfaces that extend along the longitudinal axis of the QMF, which runs in the direction of arrow 118 in the example embodiment shown in FIG. 1A). In some cases, the dielectric part extends along at least 75%, at least 90%, at least 95%, up to 100%, or more than 100% of an elongated dimension of the conductive surfaces. For instance, consider the non-limiting embodiment shown in FIG. 1A, wherein conductive surfaces 110, 112, 114, and 116 are configured to operate as electrode conductive surfaces in the QMF. In such an embodiment, if the total length of the coated QMF 100 is 10.2 cm (corresponding to the lengths of conductive surfaces 110, 112, 114, and 116) and if the dielectric part on which the conductive surfaces 110, 112, 114, and 116 are located is 10 cm long, then the dielectric part would be said to extend along 98% of the length of the electrode conductive surfaces. This is because (10 cm/10.2 cm) * 100% is 98%.

In some embodiments, each of the electrode conductive surfaces is electrically isolated from the remaining electrode conductive surfaces (e.g., until electrical connections are made between electrode pairs via wiring or another pathway). The electrode surfaces may remain electrically isolated from the other electrode conductive surfaces, for example, until the electrodes are connected in pairs. In some embodiments, each electrode conductive surface remains electrically isolated from two other electrode conductive surfaces (e.g., each of the two adjacent electrode conductive surfaces) during operation of the QMF. One example of adjacent conductive surfaces is shown in FIG. 1A, wherein conductive surfaces 110 and 112 are adjacent conductive surfaces, conductive surfaces 112 and 114 are adjacent conductive surfaces, conductive surfaces 114 and 116 are adjacent conductive surfaces, and conductive surfaces 116 and 110 are adjacent conductive surfaces. In some embodiments, the resistance between adjacent conductive surfaces is greater than or equal to 1 MΩ, greater than or equal to 10 MΩ, or greater than or equal to 100 MΩ, as measured by a multimeter at 25 degrees C. In some embodiments, the electrode conductive surfaces may be arranged to form two pairs of electrically coupled electrodes, such that the QMF may be configured for ion filtering when used in a mass spectrometer. The ion filtering can be achieved, for example, as described with respect to FIG. 7 above and/or with respect to FIG. 2F below, in accordance with certain embodiments. According to the non-limiting embodiment shown in FIGS. 1A-1D, electrically coupling electrodes may be achieved, for example, by using wires 140 shown in FIG. 1C.

According to some embodiments, the one or more conductive surfaces may comprise a plurality of conductive surfaces comprising five conductive surfaces. In some such embodiments, four electrode conductive surfaces may be similar to the above-described elongated conductive surfaces and configured for ion filtering in a QMF, and the fifth conductive surface may comprise a conductive surface formed on another surface of the dielectric part. In some cases, the fifth conductive surface may be formed on the supporting overstructure. For example, considering FIG. 1A, the overstructure 120 may be completely coated with a conductor except at connection points 130, and thus the five conductive surfaces comprise the overstructure 120 and conductive surfaces 110, 112, 114, and 116. The presence of the five conductive surfaces may arise due to the methods of fabrication, according to some embodiments, as described in more detail elsewhere herein. In some cases, the conductive surface positioned on the overstructure may not be continuous, and thus more conductive surfaces are also possible. It has been unexpectedly discovered, in the context of the present disclosure, that the presence of these additional conductive surfaces does not substantially impact performance of the QMF. The ability to tolerate such conductive surfaces present in the QMF structure (using, for example, connection points 130 to insulate the electrode conductive surfaces from the conductive surface(s) on the overstructure) can greatly simplify fabrication of the QMF. For example, in accordance with certain embodiments, all of the conductive surfaces of the QMF can be formed in a single step, as described in more detail below.

In accordance with certain embodiments, the one or more conductive surfaces may be present on a relatively large proportion of the surface area of the dielectric part. For example, in some cases, the one or more conductive surfaces are present on greater than or equal to 50%, greater than or equal to 60%, greater than or equal to 70%, greater than or equal to 80%, greater than or equal to 90%, greater than or equal to 95%, or greater than or equal to 99% of a surface area of the dielectric part. The one or more conductive surfaces, according to some embodiments, may not be present on the entire surface area of the dielectric part in order for each of the plurality of conductive surfaces to be appropriately electrically isolated. For example, connection points 130 in FIG. 1A may not be coated with a metal conductor. Accordingly, in some cases, the one or more conductive surfaces may be present on less than or equal to 99.9%, less than or equal to 99%, less than or equal to 95%, less than or equal to 90%, less than or equal to 80%, less than or equal to 70%, less than or equal to 60% of the surface area of the dielectric part. Combinations of the foregoing ranges are possible (e.g., greater than or equal to 50% and less than or equal to 90%). Other ranges are also possible. Again, the ability to tolerate such a large amount of electrically conductive surface while producing acceptable performance was unexpected and can lead to substantial simplification of the QMF fabrication process.

The electrode conductive surfaces may comprise any of a variety of suitable materials, as long as they are electrically conductive and suitable for use as electrodes in a QMF. Non-limiting examples of materials for the one or more conductive surfaces include metals, metallic alloys, conductive polymers, and carbon (e.g., graphitic carbon). The one or more conductive surfaces, in accordance with some embodiments, may comprise gold, copper, nickel, and/or nickel boron. In some embodiments, it may be useful for the material of the one or more conductive surfaces to be relatively resistant to corrosion.

The electrode conductive layers may have a thickness such that an electrical waveform having a radio frequency suitable for ion filtering in a QMF in a mass spectrometer may be applied to the electrode conductive layers without attenuation and/or disruption of the waveform due to the presence of the underlying dielectric part. In certain embodiments, the one or more conductive surfaces (e.g., one, more, or all of the electrode conductive surfaces and/or any other conductive surfaces) may be part of a conductive material layer having a thickness of greater than or equal to 0.1 microns, greater than or equal to 1 micron, greater than or equal to 5 microns, greater than or equal to 15 microns, greater than or equal to 25 microns, greater than or equal to 50 microns, greater than or equal to 100 microns, greater than or equal to 200 microns, greater than or equal to 300 microns, greater than or equal to 500 microns, or greater than or equal to 750 microns. According to some embodiments, the one or more conductive surfaces (e.g., one, more, or all of the electrode conductive surfaces and/or any other conductive surfaces) may be part of a conductive material layer having may have a thickness of less than or equal to 1 mm, less than or equal to 750 microns, less than or equal to 500 microns, less than or equal to 300 microns, less than or equal to 200 microns, less than or equal to 100 microns, less than or equal to 50 microns, less than or equal to 25 microns, less than or equal to 15 microns, less than or equal to 5 microns, or less than or equal to 1 micron. Combinations of the foregoing ranges are possible (e.g., greater than or equal to 0.1 microns and less than or equal to 1 mm). Other ranges are also possible.

In some embodiments, the electrode conductive surfaces may have any of a variety of suitable lengths. The length may affect the performance of the one or more conductive surfaces' ion filtering performance in a mass spectrometer. According to some embodiments, the length of the electrode conductive surfaces may correspond to the length of the dielectric part, as the one or more conductive surfaces may be arranged on the dielectric part. In some cases, one or more conductive surfaces may have a length of greater than or equal to 1 cm, greater than or equal to 2 cm, greater than or equal to 3 cm, greater than or equal to 5 cm, greater than or equal to 8 cm, greater than or equal to 10 cm, greater than or equal to 15 cm, greater than or equal to 25 cm, greater than or equal to 50 cm, or greater than or equal to 75 cm. In some embodiments, the electrode conductive surfaces may have a length of less than or equal to 100 cm, less than or equal to 75 cm, less than or equal to 50 cm, less than or equal to 25 cm, less than or equal to 15 cm, less than or equal to 10 cm, less than or equal to 8 cm, less than or equal to 5 cm, less than or equal to 3 cm, or less than or equal to 2 cm. Combinations of the foregoing ranges are possible (e.g., greater than or equal to 1 cm and less than or equal to 100 cm). Other ranges are also possible.

In some embodiments, the electrode conductive surfaces configured for ion filtering in a mass spectrometer may have a relatively high surface roughness. In some such cases, the relatively high surface roughness of the electrode conductive surfaces is due to additively manufacturing the dielectric part, on which the electrode conductive surfaces are positioned (e.g., plated). In the context of the present disclosure, the inventors have recognized that a QMF having electrode conductive surfaces having a relatively high surface roughness may perform adequately for ion filtering in a mass spectrometer. In some cases, a QMF having electrode conductive surfaces having a relatively high surface roughness may perform adequately for ion filtering in a miniaturized mass spectrometer. The surface roughness may be measured by using laser scanning confocal microscopy, in accordance with some embodiments. For example, the surface roughness can be measured using the ASME B46.1-2019 standard test. According to some embodiments, the surface roughness of the electrode conductive surfaces may be greater than or equal to 2 microns, greater than or equal to 5 microns, greater than or equal to 10 microns, greater than or equal to 20 microns, greater than or equal to 30 microns, greater than or equal to 50 microns, or greater than or equal to 75 microns. In certain embodiments, the surface roughness of the electrode conductive surfaces may be less than or equal to 100 microns, less than or equal to 75 microns, less than or equal to 50 microns, less than or equal to 30 microns, less than or equal to 20 microns, less than or equal to 10 microns, or less than or equal to 5 microns. Combinations of the foregoing ranges are possible (e.g., greater than or equal to 2 microns and less than or equal to 100 microns, greater than or equal to 10 microns and less than or equal to 100 microns). Other ranges are also possible.

In some cases, the QMF may further comprise an intervening layer between the dielectric part and the one or more conductive surfaces. The intervening layer may be present, for example, to promote adhesion between the dielectric part and the one or more conductive surfaces. According to some embodiments, the intervening layer may be formed on the dielectric part and used to facilitate the formation of the one or more conductive surfaces. For instance, the intervening layer may be formed on the dielectric part by sputtering, and the one or more conductive surfaces may then be plated on the intervening layer by electrolytic plating. FIG. 2B is a schematic diagram showing a non-limiting embodiment wherein the intervening layer is present. Here, conductive surface 210 is formed on the intervening layer 215. Intervening layer 215, in turn, is present on the dielectric part 220.

In certain embodiments, the intervening layer may have a thickness of greater than or equal to 20 microns, greater than or equal to 50 microns, greater than or equal to 100 microns, greater than or equal to 200 microns, greater than or equal to 300 microns, greater than or equal to 500 microns, or greater than or equal to 750 microns. According to some embodiments, the intervening layer may have a thickness of less than or equal to 1000 microns, less than or equal to 750 microns, less than or equal to 500 microns, less than or equal to 300 microns, less than or equal to 200 microns, less than or equal to 100 microns, or less than or equal to 50 microns. Combinations of the foregoing ranges are possible (e.g., greater than or equal to 20 microns and less than or equal to 1000 microns). Other ranges are also possible.

In accordance with some embodiments, as described elsewhere herein, the one or more conductive surfaces may be on the dielectric part. In some cases, the intervening layer may also be present between the dielectric part and the one or more conductive surfaces. In other cases, the one or more conductive surfaces may be directly on the dielectric part and the intervening layer may be absent.

Turning back to the dielectric part, in some embodiments, the dielectric part comprises rods. In a non-limiting embodiment, the dielectric part comprises a monolithic structure comprising four rods having a hyperbolic shape, wherein the rods are shells with an internal truss structure and which are supported by struts (e.g., hefty struts). FIG. 2C shows a non-limiting embodiment of a hyperbolically shaped rod 240. In FIG. 2D, multiple hyperbolically shaped rods 240 are present, mechanically inseparable, and integrally formed in the dielectric part 244. Here, the dielectric part 244 comprises four hyperbolically shaped rods 240, which are configured to be coated with a conductor and subsequently operated as a QMF. The rods, internal truss structure, and hefty struts of the dielectric part may be integrally connected and/or mechanically inseparable to form the monolithic structure. For instance, FIG. 2E shows the outer overstructure connecting such surfaces (e.g., on the rods) of one such dielectric part. In some such cases, the corners of the rods are not directly connected. For example, consider FIG. 1A, where the corners of rods comprising electrode conductive surfaces 110, 112, 114, and 116 are not in physical contact with each other.

The dielectric part may comprise any of a variety of suitable materials, according to some embodiments. Generally, the materials from which the dielectric part is made will be electrically insulting. In some cases, the dielectric part may comprise a polymer. In some cases, the dielectric part may comprise ceramics and/or polymers. In some cases, the dielectric part may comprise polymers and/or inorganic particles. In some embodiments, the dielectric part is made of glass ceramic photocurable polymer resin (e.g., Tethon Vitrolite®). According to some embodiments, the dielectric part is not a quartz monolith. According to some embodiments, the dielectric part does not comprise silica. According to some embodiments, the dielectric part does not comprise quartz. In some embodiments, the QMF does not comprise quartz. According to some embodiments, the dielectric part does not comprise silica. In some embodiments, the QMF does not comprise silica. In some cases, as described elsewhere herein, it may be particularly advantageous when the dielectric part is made by additive manufacturing, and thus the dielectric part may comprise a material suitable for additive manufacturing.

Conventionally, after additively manufacturing a part using a resin comprising polymeric materials and inorganic materials, the resins are intended to be fired (e.g., heated) to remove the polymeric material from the additively manufactured part. In some such cases, the resin may be particularly susceptible to degradation, deformation, and/or any other type of irreversible damage before firing. However, the inventors have recognized in the context of the present disclosure that dielectric parts comprising resins comprising polymers and inorganic particles may be sufficiently robust to withstand the deposition of a metal conductor and/or for use in QMFs without firing the dielectric part, in some embodiments. In some embodiments, dielectric parts comprising resins comprising polymers and inorganic particles may be sufficiently robust without firing to withstand deposition conditions during electroless plating. In some cases, a dielectric part comprising a composite of a polymer and inorganic particles may be configured for use in the QMF after being additively manufactured and without firing. In some such embodiments, eliminating the need for firing the additively manufactured part may avoid changing the dimensions of the dielectric part that may occur during firing (e.g., due to removing the polymer) and/or reduce manufacturing time.

The dielectric part may have any of a variety of build volumes. Build volume generally refers to the total volume of space in which the part resides, and it includes both the space occupied by the solid material of the part as well as the internal voids of the part. The build volume of the part (e.g., when the QMF is configured for use in a miniaturized mass spectrometer) may be less than or equal to 1000 cm³, less than or equal to 900 cm³, less than or equal to 800 cm³, less than or equal to 700 cm³, less than or equal to 600 cm³, less than or equal to 500 cm³, less than or equal to 400 cm³, less than or equal to 300 cm³, less than or equal to 200 cm³, or less than or equal to 100 cm³. In some embodiments, the dielectric part may have a build volume of 110×60×138 mm. Other build volumes are also possible, for example, when the dielectric part is intended to be configured as a QMF and used in a conventionally sized mass spectrometer. For example, in some embodiments, the build volume of the dielectric part may be greater than or equal to 500 cm³, greater than or equal to 1000 cm³, greater than or equal to 2000 cm³, greater than or equal to 3000 cm³, greater than or equal to 5000 cm³, or greater than or equal to 10000 cm³. In some cases, the build volume of the dielectric part may be less than or equal to 15000 cm³, less than or equal to 10000 cm³, less than or equal to 5000 cm³, less than or equal to 3000 cm³, or less than or equal to 2000 cm³. Combinations of the foregoing ranges are possible (e.g., greater than or equal to 500 cm³ and less than or equal to 15000 cm³). Other ranges are also possible.

Any of a variety of volumes of resin may be used to construct the dielectric part, according to some embodiments. In some cases, the resin may be used during additive manufacturing of the dielectric part. The volume of the resin used to make the dielectric part may be less than or equal to 700 cm³, less than or equal to 600 cm³, less than or equal to 500 cm³, less than or equal to 400 cm³, less than or equal to 300 cm³, less than or equal to 200 cm³, less than or equal to 100 cm³, or less than or equal to 50 cm³, in accordance with some embodiments in which the dielectric part is used in a QMF of a miniaturized mass spectrometer. Other volumes of resin are also possible, for example, when the dielectric part is intended to be configured as a QMF and used in a conventionally sized mass spectrometer. In some embodiments, the volume of resin used to make the dielectric part may be greater than or equal to 10 cm³, greater than or equal to 100 cm³, greater than or equal to 200 cm³, greater than or equal to 300 cm³, greater than or equal to 400 cm³, greater than or equal to 500 cm³, greater than or equal to 1000 cm³, greater than or equal to 2000 cm³, greater than or equal to 3000 cm³, greater than or equal to 5000 cm³, or greater than or equal to 10000 cm³. In some cases, the volume of resin used to make the dielectric part may be less than or equal to 15000 cm³, less than or equal to 1000 cm³, less than or equal to 5000 cm³, less than or equal to 3000 cm³, less than or equal to 2000 cm³, or less than or equal to 1000 cm³. Combinations of the foregoing ranges are possible (e.g., greater than or equal to 10 cm³ and less than or equal to 200 cm³). Other ranges are also possible.

The dielectric part and the one or more conductive surfaces of the QMF may have any of a variety of suitable sizes, in accordance with certain embodiments. In some cases, the QMF may be configured for a conventionally sized mass spectrometer. In some embodiments, the QMF may be miniaturized, and thus configured for use within a miniaturized mass spectrometer. The size of the QMF (e.g., the volume), in some cases, will be primarily determined by the size of the dielectric part, as in some such cases, the one or more conductive surfaces have a relatively small contribution to the overall volume of the QMF.

In some embodiments, the QMF may comprise four conductive surfaces on a dielectric part, wherein the four conductive surfaces are arranged to form two pairs of electrodes configured for ion filtering in a mass spectrometer and wherein the electrodes may be spaced by any of a variety of suitable distances. That is, in some cases, the conductive surfaces opposite each other (e.g., see FIG. 1A, elements 110 and 114, which are opposite each other, and elements 112 and 116, which are also opposite each other) may be spaced by greater than or equal to 100 microns, greater than or equal to 500 microns, greater than or equal to 1 mm, greater than or equal to 2 mm, greater than or equal to 3 mm, greater than or equal to 5 mm, greater than or equal to 8 mm, or greater than or equal to 10 mm. According to some embodiments, the conductive surfaces opposite each other may be spaced by less than or equal to 12 mm, less than or equal to 10 mm, less than or equal to 8 mm, less than or equal to 5 mm, less than or equal to 3 mm, less than or equal to 2 mm, less than or equal to 1 mm, or less than or equal to 500 microns. Combinations of the foregoing ranges are possible (e.g., greater than or equal to 1 mm and less than or equal to 12 mm). Other ranges are also possible.

In some embodiments, as mentioned above, the one or more conductive surfaces may have any of a variety of suitable lengths, wherein the length may affect the resolving power of the mass spectrometer comprising the QMF comprising the one or more conductive surfaces. Accordingly, the QMF may have any of a variety of suitable lengths to accommodate the one or more conductive surfaces. In some cases, QMF may have a length of greater than or equal to 1 cm, greater than or equal to 2 cm, greater than or equal to 3 cm, greater than or equal to 5 cm, greater than or equal to 8 cm, greater than or equal to 10 cm, greater than or equal to 15 cm, greater than or equal to 25 cm, greater than or equal to 50 cm, greater than or equal to 75 cm, or greater than or equal to 100 cm. In some embodiments, the QMF may have a length of less than or equal to 125 cm, less than or equal to 100 cm, less than or equal to 75 cm, less than or equal to 50 cm, less than or equal to 25 cm, less than or equal to 15 cm, less than or equal to 10 cm, less than or equal to 8 cm, less than or equal to 5 cm, less than or equal to 3 cm, or less than or equal to 2 cm. Combinations of the foregoing ranges are possible (e.g., greater than or equal to 1 cm and less than or equal to 125 cm). Other ranges are also possible.

The performance of the QMF may vary, in accordance with some embodiments, based on the dimensions of the dielectric part and/or the surface roughness of the electrode conductive surfaces configured for ion filtering. According to some embodiments, the quadrupole mass filter described in the present disclosure may provide adequate performance for PoC analysis. In certain cases, the quadrupole may provide performance near to and/or equivalent to conventionally sized mass spectrometers (e.g., not miniaturized). In some embodiments, the quadrupole may provide performance near to and/or equivalent to mass spectrometers comprising four high-precision, machined cylindrical electrodes aligned with a bracket component (e.g., not monolithic). In accordance with some embodiments, this may be particularly advantageous given the miniaturized size of the QMF and/or the ability to additively manufacture the QMF. For example, in some cases, the QMF may filter Ar (e.g., at 40 Da with an absolute charge value of 1) such that the Ar peak has a full width at half maximum of less than or equal to 10 Da, less than or equal to 8 Da, less than or equal to 6 Da, less than or equal to 4 Da, less than or equal to 2 Da, less than or equal to 1 Da, or less than or equal to 0.5 Da. Note that the foregoing values are given in Da, but represent an m/z value for Ar that is singly charged (i.e., z=+1 or −1).

According to some embodiments, the QMF is configured to filter compounds having an initial mass (e.g., before activation and/or fracturing of the proteins and/or compounds of interest during ionization) of greater than or equal to 10 Da greater than or equal to 1 kDa, greater than or equal to 5 kDa, greater than or equal to 10 kDa, greater than or equal to 20 kDa, greater than or equal to 50 kDa, greater than or equal to 100 kDa, greater than or equal to 250 kDa, greater than or equal to 500 kDa, greater than or equal to 750 kDa, greater than or equal to 1MDa, or greater than or equal to 5 MDa. In certain embodiments, the QMF is configured to filter compounds having an initial mass of less than or equal to 10 MDa, less than or equal to 5 MDa, less than or equal to 1 MDa, less than or equal to 750 kDa, less than or equal to 500 kDa, less than or equal to 250 kDa, less than or equal to 100 kDa, less than or equal to 50 kDa, less than or equal to 20 kDa, less than or equal to 10 kDa, less than or equal to 5 kDa, or less than or equal to 1 kDa. Combinations of the foregoing ranges are possible (e.g., greater than or equal to 10 Da and less than or equal to 10 MDa, greater than or equal to 10 Da and less than or equal to 1 MDa). Other ranges are also possible.

In some cases, the QMF may be capable of filtering ions having an m/z value of greater than or equal to 10, greater than or equal to 10, greater than or equal to 100, greater than or equal to 500, greater than or equal to 1000, or greater than or equal to 2000. In certain embodiments, the QMF may be capable of filtering ions having an m/z value of less than or equal to 3000, less than or equal to 2000, less than or equal to 1000, less than or equal to 500, less than or equal to 100, or less than or equal to 10. Combinations of the foregoing ranges are possible (e.g., an m/z of greater than or equal to 1 and less than or equal to 3000, an m/z of greater than or equal to 1 and less than or equal to 2000). Other ranges are also possible.

The absolute amount of sample required by the QMF to measure a signal, according to some embodiments, may be relatively small. This may be due, in some cases, to the miniaturized size of the QMF and/or the sensitivity of the QMF, both factors leading to correspondingly small requirements for sample injections. In certain embodiments, the amount of sample injected into the QMF to measure a signal may be greater than or equal to 1 femtogram, greater than or equal to 10 femtogram, greater than or equal to 100 femtogram, greater than or equal to 1 picogram, greater than or equal to 10 picogram, greater than or equal to 100 picogram, greater than or equal to 1 nanogram, greater than or equal to 10 nanogram, or greater than or equal to 100 nanogram of sample. In some embodiments, the amount of sample injected into the QMF may be less than or equal to 1 microgram, less than or equal to 100 nanogram, less than or equal to 10 nanogram, less than or equal to 1 nanogram, less than or equal to 100 picogram, less than or equal to 10 picogram, less than or equal to 1 picogram, less than or equal to 100 femtogram, or less than or equal to 10 femtogram. Combinations of the foregoing ranges are possible (e.g., greater than or equal to 1 femtogram and less than or equal to 1 microgram). Other ranges are also possible.

Some aspects of the present disclosure are related to methods for fabricating and/or using the QMFs described elsewhere herein.

In some cases, at least a portion of the QMF (e.g., at least 50 wt%, at least 75 wt%, at least 90 wt%, at least 95 wt%, or more) may be made by applying transverse sections to produce the QMF or a component thereof. In some embodiments, at least a portion of the dielectric part of the QMF (e.g., at least 50 wt%, at least 75 wt%, at least 90 wt%, at least 95 wt%, at least 98 wt%, at least 99 wt%, or 100 wt% of the dielectric part) may be made by applying transverse sections to produce the dielectric part or a component thereof. In some such cases, a printer may be used to apply the transverse sections, wherein the printer is optionally a 3-D printer (e.g., a Bison 1000 DLP Printer). Accordingly, in some embodiments, the dielectric part of the QMF may be additively manufactured (e.g., 3-D printed). In some such cases, it may be desirable to apply antialiasing to the slicing data before additively manufacturing the dielectric part. In some embodiments, forming the dielectric part and/or the QMF can comprise applying at least 10, at least 50, at least 100, at least 500, at least 1000, or more (e.g., up to 10,000, up to 100,000, up to 1,000,000, or more) transverse sections.

For the QMF (e.g., the component of the mass spectrometer that sorts the components of the ionized sample based on their mass-to-charge ratio in vacuum), additive manufacturing introduces various benefits, including the ability to use an arbitrary electrode geometry, precision electrode alignment, and/or efficient use of device space. Each benefit may facilitate high performing and/or miniaturized QMFs. In some cases, additive manufacturing may be more cost-effective than using other methods of making QMFs for ion filtering in mass spectrometers.

In accordance with certain embodiments, a printer may be used to apply transverse sections to produce a dielectric part with rods 1-100 cm long surrounding a hole with 1-100 mm inner diameter. In some such embodiments, the dielectric part may be mounted on a set of pillars. In some cases, the block of resin used to make the dielectric part has a build volume of 110×60×138 mm.

In some embodiments, making the QMF may comprise masking one or more surfaces of the dielectric part, thereby making a partially masked dielectric part (e.g., a 3-D printed part). In some such cases, masking may comprise lacquering, e.g., applying a lacquer to the one or more surfaces. Accordingly, in some embodiments, making the QMF may comprise lacquering one or more surfaces of the printed part to produce a partially masked dielectric part. Masking one or more surfaces of the dielectric part, in accordance with some embodiments, may facilitate the electrical isolation of the electrode conductive surfaces once formed. For example, referring again to FIG. 1A, the dielectric part may only be masked at connection points 130. In some cases, the dielectric part may be masked manually (e.g., by hand) and/or by automated procedure.

In some embodiments, the maskant may be applied to less than or equal to 50%, less than or equal to 40%, less than or equal to 30%, less than or equal to 20%, less than or equal to 10%, less than or equal to 5%, or less than or equal to 1% (and/or, as little as 0.1%, as little as 0.01%, as little as 0.001%, as little as 0.0001%, as little as 0.00001%, or less) of the surface area of the dielectric part.

According to some embodiments, making the QMF further comprises positioning metal over the partially masked dielectric part to produce one or more electrically conductive surfaces on the dielectric part. The metal positioning step can, in some embodiments, result in the formation of the four electrode conductive surfaces in a single step. In some such cases, the metal positioning step can result in the formation of the four electrode conductive surfaces and a fifth (and/or more) conductive surface in a single step. Any of a variety of methods are suitable for positioning metal over the partially masked dielectric part. For example, positioning metal over the partially masked dielectric part may comprise plating over the partially masked dielectric part, wherein, in some cases, plating may comprise electroless plating. In accordance with some embodiments, plating the partially masked dielectric part (e.g., the lacquered printed part) with a metal conductor may produce one or more electrically conductive surfaces on the partially masked dielectric part. Other, non-limiting, example methods include physical vapor deposition (e.g., sputtering) and chemical vapor deposition methods (e.g., atomic layer deposition). In some embodiments, any of the foregoing methods may be used to form at least a partial conductive surface on the dielectric part, whereby subsequent electrolytic deposition may be used to form one or more complete conductive surface on the dielectric part. It may be particularly advantageous to position metal over the partially masked dielectric part by electroless plating of the conductive surface.

In some cases, making the QMF may comprise positioning metal over the dielectric part (e.g., not a partially masked dielectric part) with a metal conductor to produce one or more electrically conductive surfaces on the dielectric part. That is, in some such cases, no masking step may be performed. According to some embodiments wherein no masking step is performed, it may prove desirable to remove the metal conductor from at least a portion of the dielectric part, for example from connection points 130 shown in the non-limiting embodiment of FIG. 1A. Such removal may be performed by, for instance, physical abrasion and/or chemical dissolution and/or etching at specific locations on the dielectric part.

Making the QMF, in some cases, further comprises removing the mask from the partially masked dielectric part. Removing the mask can also result in the removal of the conductor material overlying the mask, which can lead to the electrical isolation of the conductive materials on either side of the mask. In some such cases, removing the mask from the partially masked dielectric part produces a finished QMF, for example, which may be configured for ion filtering in a mass spectrometer. According to some embodiments, removing the mask may comprise removing the lacquer masking from the partially masked dielectric part (e.g., the printed part). Examples of methods for removing the mask (e.g., the lacquer), according to some embodiments, include physical abrasion and chemical dissolution. Other methods are also possible, as this disclosure is not so limited. Removing the mask, in some cases, may produce electrically conductive surfaces, which, in some embodiments, may be rods. The finished QMF, in accordance with some embodiments, may be configured for ion filtering in a mass spectrometer.

The QMFs described herein, in some embodiments, may be configured for ion filtering in a mass spectrometer. In some such cases, the QMF may be operatively coupled to any of a variety of components used in a typical mass spectrometer. For example, consider FIG. 2F, showing mass spectrometer 258 comprising an ionizer 250, lenses 252, QMF 254, and detector 256. Ionizer 250 may be any of a variety of ion sources, for example an electron ionization ion source, collision induced dissociation ion source, thermal ionization ion source, inductively coupled plasma ion source, and/or a photodissociation ion source. In accordance with certain embodiments, sample 260 may be transported to ionizer 250 to produce ions 262. Ions 262 can then be transported into QMF 254 such that filtered ions 264 are produced. Filtered ions 264 can be detected by detector 256. In certain embodiments, the mass spectrometer may be further operatively coupled with a separation column to purify a sample before filtering it further in the mass spectrometer. The separation column may be a high-pressure liquid chromatography column and/or a gas chromatography column, according to some embodiments. In some embodiments, some or all of the mass spectrometer may be positioned within a vacuum to perform mass spectrometry. According to some embodiments, the mass spectrometer may be configured to operate in the positive ion mode or the negative ion mode.

The following describes a non-limiting example of a design of a QMF, in accordance with certain embodiments described herein, which is a nickel electroless plated, monolithic QMF with hyperbolic rods printed by vat polymerization of a glass-ceramic resin.

There are significant challenges with monolithic QMF designs. Firstly, monolithic QMFs necessarily have electrodes mechanically inseparable from each other; therefore, blank metallization of this part will form electrically connected rods, which is impossible to drive as a QMF. To overcome this challenge, lacquer-based maskant was used to coat structural points designed to be electrically insulated, followed by electroless plating, yielding electrically-isolated, conducting rods. Second, the discrete nature of vat polymerization (prints are made of voxels) poses challenges to creating precision surfaces. Staircase-like and/or pixelated surfaces result in field aberrations detrimental to filter performance. Therefore, the fabrication process was optimized to maximize topology precision, attaining a standard deviation of 13 μm across the printable volume. The quadrupole was also designed to be printed as a series of identical, transverse sections with antialiasing applied to the slicing data, minimizing pixelation of the electrode surface. The final QMF has rods 2 cm long with 4 mm inner diameter between the conductive surfaces.

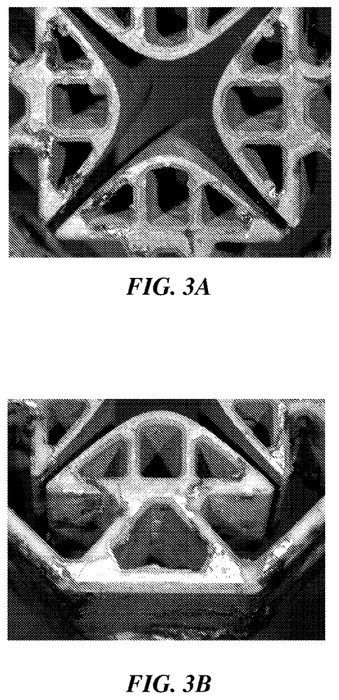

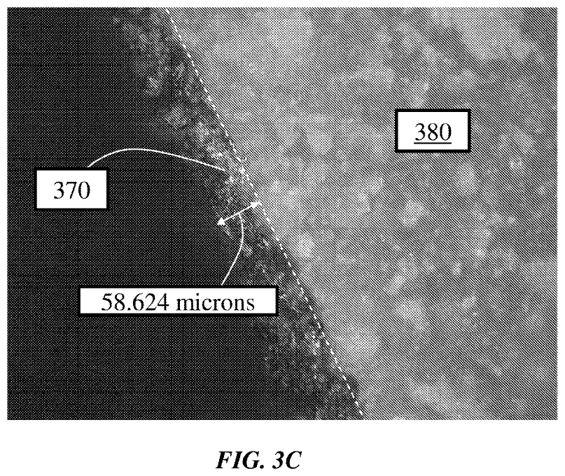

FIGS. 3A-3B are micrographs of a non-limiting example of a QMF. Since additive manufacturing is largely indifferent to device geometry, the electrode surfaces of the tested QMF were shaped like hyperbolas, which is a more ideal shape than the typical circular rod that is commonly used among commercial QMFs. FIG. 3C shows a cross-sectional image of a conductive surface 370 on the dielectric part 380 acquired with a laser scanning confocal microscope. An approximate boundary between the conductive surface 370 and the dielectric part 380 is outlined with the white dashed line. The thickness of the conductive layer is approximately 58.624 microns, and the surface roughness of the conductive surface is a fraction of its 58.624 micron thickness.

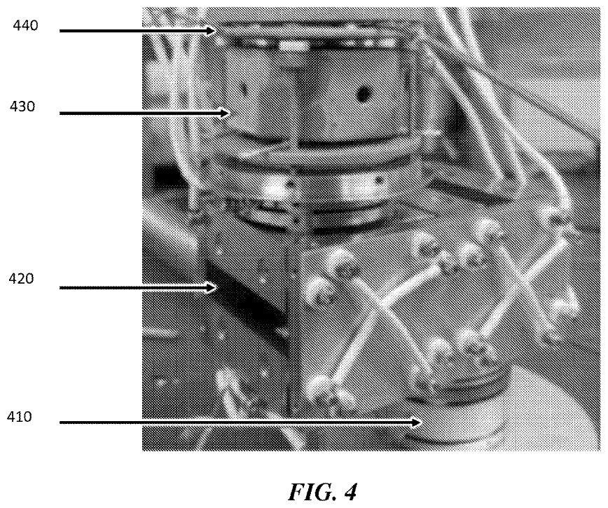

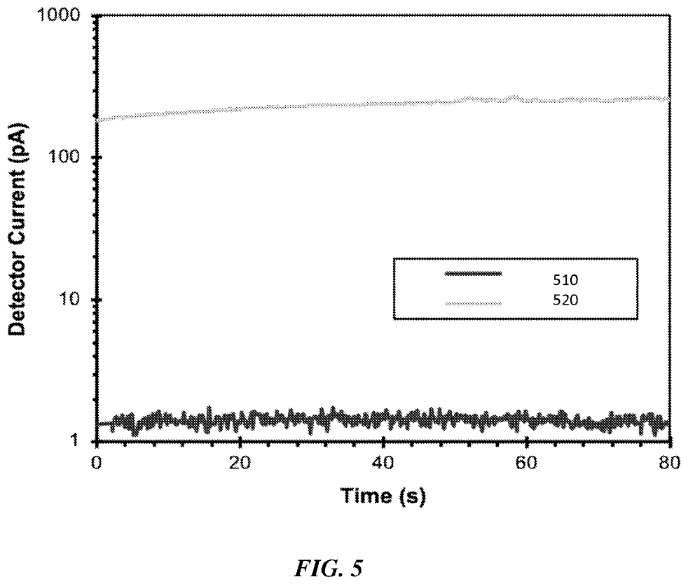

Preliminary experiments were performed using the experimental setup shown in FIG. 4, wherein the QMF 430 was arranged with an ionizer 410, quadrupole beam deflector 420, and a detector plate 440 and was configured to operate as a mass analyzer. The experimental setup in FIG. 4 was used to demonstrate the filtering power of the example QMF, wherein, with the device in vacuum, ionized argon was fed on one side of the quadrupole and detected by a Faraday cup on the opposite side (e.g., the detector plate 440). FIG. 5 shows data obtained using the experimental setup of FIG. 4. Here, two orders of magnitude of difference in detector current was observed when the quadrupole fields were set to transmit (520) or reject (510) argon. This result demonstrates the utility of the QMF for selectively transmitting ions, despite the low aspect ratio of the QMF tested.

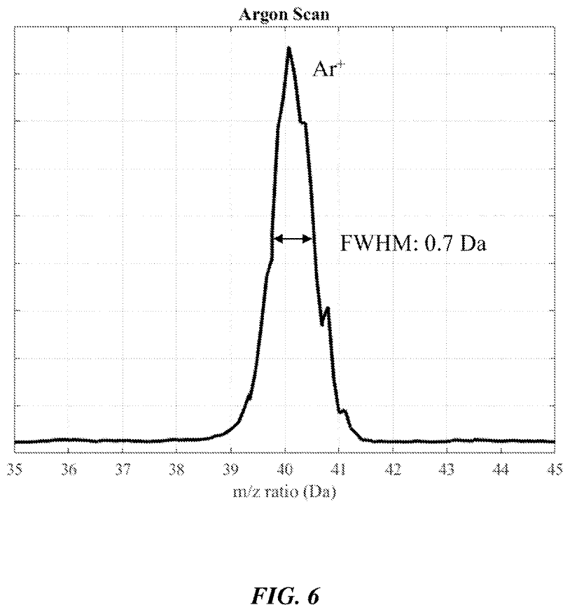

FIG. 6 shows a mass spectrum obtained using the example QMF configured for ion filtering in a mass spectrometer. The mass spectrum shows the peak obtained for singly charged Ar at 40 Da (e.g., 40 m/z). Here the Ar⁺ peak has a full width half maximum (FWHM) of approximately 0.7 Da, demonstrating the resolving power of the QMF when filtering ions.

In addition to the demonstrated performance, as described previously, additively manufacturing the QMF provided benefits such as facilitating arbitrary electrode geometry, precision electrode alignment, and efficient use of device space. Additionally, the monolithic design of the part ensured that all the rods were printed in a pre-aligned manner, eliminating the need for mounting hardware and alignment procedures and facilitating the high quality performance of the QMF, as demonstrated in FIGS. 5-6. Finally, the overstructure of the dielectric part was kept to a low profile in order to minimize its size, which may improve portability and/or compactness of the final mass spectrometer comprising the QMF.

It should be understood that the subject matter defined in the appended claims is not necessarily limited to the specific implementations described above. The specific implementations described above are disclosed as examples only.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

As used herein, “wt%” is an abbreviation of weight percentage.

Some embodiments may be embodied as a method, of which various examples have been described. The acts performed as part of the methods may be ordered in any suitable way. Accordingly, embodiments may be constructed in which acts are performed in an order different than illustrated, which may include different (e.g., more or less) acts than those that are described, and/or that may involve performing some acts simultaneously, even though the acts are shown as being performed sequentially in the embodiments specifically described above.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A quadrupole mass filter (QMF) comprising:
a dielectric part comprising a composite of a photocured polymer resin and ceramic particles; and
one or more electrically conductive surfaces on the dielectric part,
wherein the one or more conductive surfaces are present on greater than or equal to 50% of a surface area of the dielectric part.

2. The QMF of claim 1,
wherein the QMF is configured for ion filtering in a mass spectrometer.

3. (canceled)

4. The QMF of claim 1,
wherein the dielectric part is made by additive manufacturing.

5. The QMF of claim 1,
wherein the QMF does not comprise silica.

6. The QMF of claim 1,
wherein the QMF is monolithic.

7. The QMF of claim 1, wherein the one or more electrically conductive surfaces comprises four electrically conductive electrodes.

8. (canceled)

9. The QMF of claim 8, wherein the four electrically conductive electrodes are arranged to form two pairs of electrically coupled electrodes.

10. The QMF of claim 8, wherein the cross-sectional shape of each of the four electrode conductive surfaces is hyperbolic.

11. The QMF of claim 8, wherein a surface roughness of each of the four electrode conductive surfaces is greater than or equal to 2 microns and less than or equal to 100 microns as measured by the ASME B46.1-2019 standard test.

12. (canceled)

13. The QMF of claim 9, wherein each of the four electrically conductive electrodes is elongated, with an elongated dimension of each of the four electrically conductive electrodes aligned along a longitudinal axis of the QMF.

14-20. (canceled)

21. The QMF of claim 1, wherein the one or more electrically conductive surfaces comprise five electrically conductive surfaces.

22. (canceled)

23. The QMF of claim 1, wherein each of the one or more electrically conductive surfaces is formed directly on the dielectric part.

24. (canceled)

25. (canceled)

26. The QMF of claim 1, wherein the QMF is configured to filter a peak having full width at half maximum of 1 Da or less for Ar⁺ at 40 Da and configured to filter compounds having a m/z of less than or equal to 3000.

27. (canceled)

28-33. (canceled)

34. A method of making a quadrupole mass filter (QMF), the method comprising:
forming the dielectric part of claim 1 by additive manufacturing;
forming a mask on one or more surfaces of the dielectric part to produce a partially masked dielectric part;
positioning metal over the partially masked dielectric part to produce one or more electrically conductive surfaces on the dielectric part; and
removing the mask from the partially masked dielectric part to yield the QMF of claim 1.

35-53. (canceled)

54. A quadrupole mass filter (QMF) comprising:
a monolithic structure, wherein the monolithic structure comprises:
four rods having a hyperbolic cross-sectional shape, where the rods are shells with an internal truss structure and corners of the four rods are not directly connected;
struts supporting each of the four rods; and
an enclosure.

55. The QMF of claim 54, wherein the QMF is coated with a plating comprising copper, gold, or nickel boron.

56. The QMF of claim 55, wherein the plating has a thickness greater than or equal to 1 μm and less than or equal to 300 μm.

57. The QMF of claim 54, wherein each of the four rods is galvanically isolated from the others.

58. The QMF claim 54, wherein the resistance between electrodes is greater than 100 MΩ.

59. The QMF of claim 54, wherein the enclosure is a cylindrical enclosure.
